(19) United States
(12) Patent Application Publication
(10) Pub. No.: US 2005/0250046 A1
(43) Pub. Date: Nov. 10, 2005

(54) Hologram recording medium and apparatus for and method of recording data on the recording medium

(75) Inventors: Ikuo Aoki, Yokohama (JP); Yoshitaka Takahashi, Yokohama (JP)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/114,147

(22) Filed: Apr. 26, 2005

(30) Foreign Application Priority Data
May 7, 2004 (JP) 2004-138528
Oct. 5, 2004 (KR) 2004-79208

(51) Int. Cl. G11B 7/24

(52) U.S. Cl. 430/270.11

(57) ABSTRACT

A hologram recording medium and apparatus for and method of recording data on the recording medium. The recording medium is a card shaped hologram recording medium having an auxiliary recording area at a periphery of a main or user data recording area. Address information is recorded along one or two sides of the main or user data recording area. The recording medium may also be divided into a plurality of user data areas each having associated address data on the one or two sides. A recording location is determined by reference to the address information.

This application claims the benefit of Japanese Patent Application No. 2004-138528, filed on May 7, 2004 in the Japanese Intellectual Property Office and the benefit of Korean Patent Application No. 2004-79208, filed on Oct. 5, 2004 in the Korean Intellectual Property Office, the disclosures of which are incorporated herein by reference.

### BACKGROUND OF THE INVENTION

1. Field of the Invention

The present invention relates to a recording medium, and more particularly, to a hologram recording medium for recording information as interference fringes by using an object beam and a reference beam.

2. Description of the Related Art

Recently, a rewritable optical disk of a phase transition type and an optical magnetic type have been widely used as information recording media. In order to increase a recording density of such an optical disk, it is required to reduce the diameter of a beam spot and the distance between adjacent tracks or adjacent bits.

Although the recording density of an optical disk has been increased, the recording density of an optical disk is physically limited by a diffraction limit of a beam for recording data on a surface. Accordingly, a three-dimensional multi-recording including a depth direction is required to increase the recording density of the optical recording medium.

Accordingly, a hologram recording medium having a large capacity due to a three-dimensional multi-recording region and that can be used at high speed due to a two-dimensional recording/reproducing method has attracted public attention as a next generation of computer recording media. Such a hologram recording medium may be formed by inserting a recording layer formed of a photopolymer between two sheets of glass. In order to record data on the hologram recording medium, an object beam and a reference beam corresponding to data to be recorded are irradiated to the hologram recording medium to form interference fringes by change of a refractive index of a recording material. In order to reproduce data from the hologram recording medium, a reference beam is irradiated to the interference stripes to extract optical data corresponding to the recorded data.

In addition, hologram recording media have been provided in various shapes such as a cube shape or a card shape. For example, Japanese Laid-open Patent No. 2000-67204 discloses a card shaped hologram recording medium having multiple recording layers on which a waveguide is formed in order to increase a recording capacity.

In general, when recording/reproducing data on/from a hologram recording medium, data is recorded or reproduced in a horizontal direction along reference lines, as shown in FIG. 1. At the end of the reference line, the recording or the reproducing is stopped to move to an adjacent reference line, and then the recording or the reproducing of data is repeated in the horizontal direction along the adjacent reference line. Such a method is proper for a case of continuously recording or reproducing series of data. However, such a method requires address data when recording information following previously recorded data or when searching and reproducing predetermined data.

### SUMMARY OF THE INVENTION

The present invention provides a hologram recording medium that allows address data recorded thereon to be the address data being recorded so that a decrease of a recording capacity of the hologram recording medium is minimized.

According to an aspect of the present invention, there is provided a card shaped hologram recording medium comprising an auxiliary recording area efficiently arranged at a periphery of a main data recording area. Address data may be included in the auxiliary recording area. Accordingly, an optical data may be precisely detected in a short time by using the address data.

The auxiliary recording area may be arranged at the periphery of the hologram recording medium and the address data may be arranged at least at one side of the auxiliary recording area. Accordingly, the optical data may be precisely detected in a short time by using the address data.

According to another aspect of the present invention, there is provided a card shaped hologram recording medium comprising a main data recording area, which is divided into a plurality of zones, and auxiliary recording areas arranged at respective peripheries of the zones of the main data recording areas. Accordingly, the auxiliary recording areas may be efficiently arranged in each zone, and files in each zone may be easily managed. The auxiliary recording areas may include address data.

In this case, since the auxiliary recording areas including the address data may be arranged at the peripheries of the zones of the main data recording areas, optional data in the zone may be rapidly and precisely detected by using the address data. The auxiliary recording areas are arranged at the peripheries of the zones of the main data recording areas and the address data are arranged at least at one side of the auxiliary recording areas.

Accordingly, optional data may be rapidly and precisely detected by using the address data in each zone. The address data may be formed of printed marks, concave units or convex units. Accordingly, the address data may be formed in a simple structure.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a conventional method of recording information.

FIG. 2 illustrates a basic outline of a hologram recording medium according to an aspect of the present invention;

FIG. 3 illustrates a basic outline of a hologram recording medium whose main data recording area is divided into a plurality of zones according to the present invention;

FIG. 4A illustrates a hologram recording medium in which address data is arranged at one peripheral portion according to a first embodiment of the present invention;

FIG. 4B illustrates a hologram recording medium in which address data is arranged at two peripheral portions according to the first embodiment of the invention;

FIG. 5 illustrates a hologram recording medium in which address data is arranged at one peripheral portion of each zone according to the first embodiment of the present invention;

FIG. 6 illustrates a hologram recording medium in which address data are arranged at two peripheral portions according to a second embodiment of the present invention;

FIG. 7A illustrates a hologram recording medium in which address data are arranged at two peripheral portions of each zone according to the second embodiment of the present invention;

FIG. 7B illustrates another hologram recording medium in which address data are arranged at two peripheral portions of each zone according to the second embodiment of the present invention;

FIG. 8 illustrates a hologram recording medium in which address data are arranged at peripheral portions according to a third embodiment of the present invention;

FIG. 9 illustrates a hologram recording medium in which address data are arranged at peripheral portions of each zone according to the third embodiment of the present invention;

FIG. 10 is a sectional view of a hologram recording medium according to an embodiment of the present invention;

FIG. 11A is a flow diagram of a first method of locating a recording/reproducing address on a hologram recording medium of the present invention;

FIG. 11B is a flow diagram of a second method of locating a recording/reproducing address on a hologram recording medium of the present invention;

FIG. 12A is a flow diagram of a third method of locating a recording/reproducing address on a hologram recording medium of the present invention;

FIG. 12B is a flow diagram of a fourth method of locating a recording/reproducing address on a hologram recording medium of the present invention; and

FIG. 13 is a block diagram illustrating a recording/reproducing apparatus for a hologram recording medium according to the present invention.

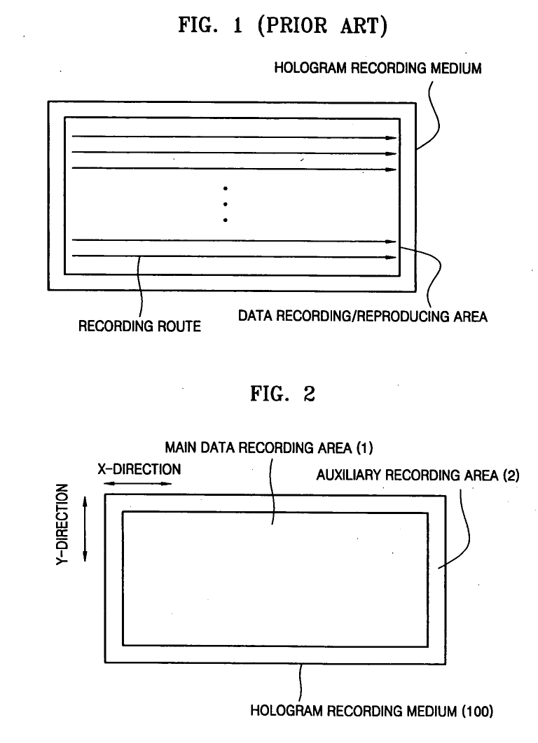

### DETAILED DESCRIPTION OF THE INVENTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 2 is an outline of a hologram recording medium 100 according to aspects of the present invention. Referring to FIG. 2, the hologram recording medium 100 comprises a main (or user) data recording area 1 for recording information which is desired to be reproduced and an auxiliary recording area 2 formed at a periphery of the main data recording area 1. The information recorded in the auxiliary recording area 2 includes information other than the main data recorded in the main data recording area 1, such as for example, address data. In addition, the information recorded in the auxiliary recording area 2 may be formed of printed marks or grooves such as concave units or convex units.

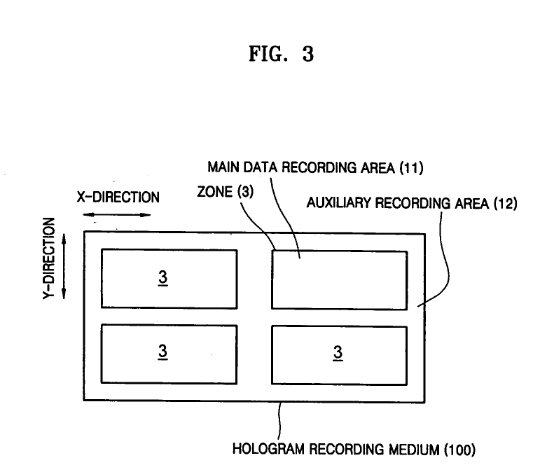

FIG. 3 illustrates a hologram recording medium 100 having a main data recording area 11 divided into a plurality of zones 3. In this case, auxiliary recording areas 12 are formed at the peripheries of the zones 3 of the main data recording area 11.

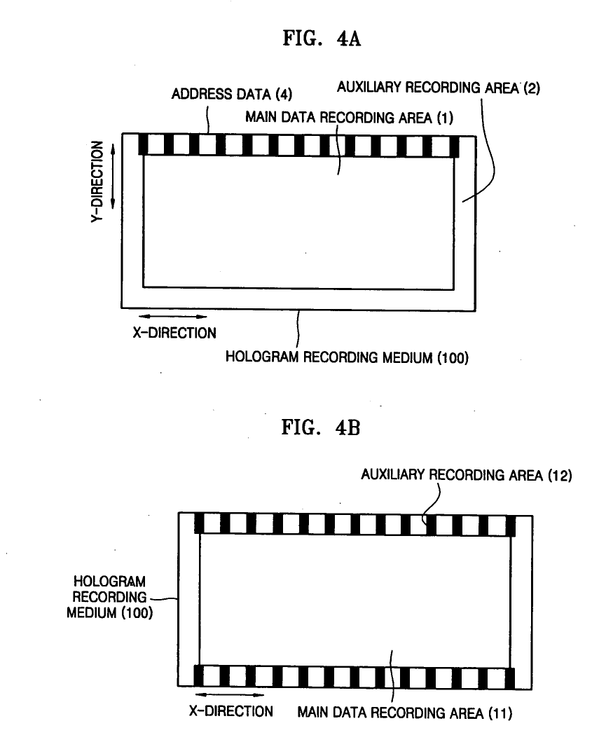

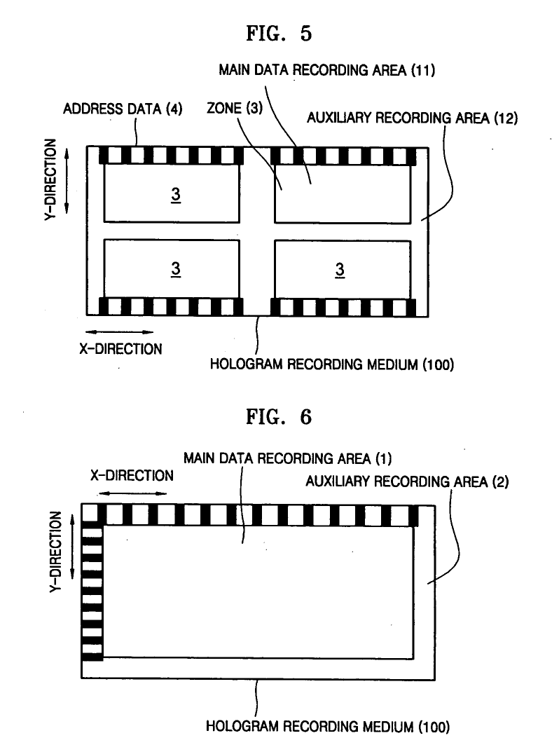

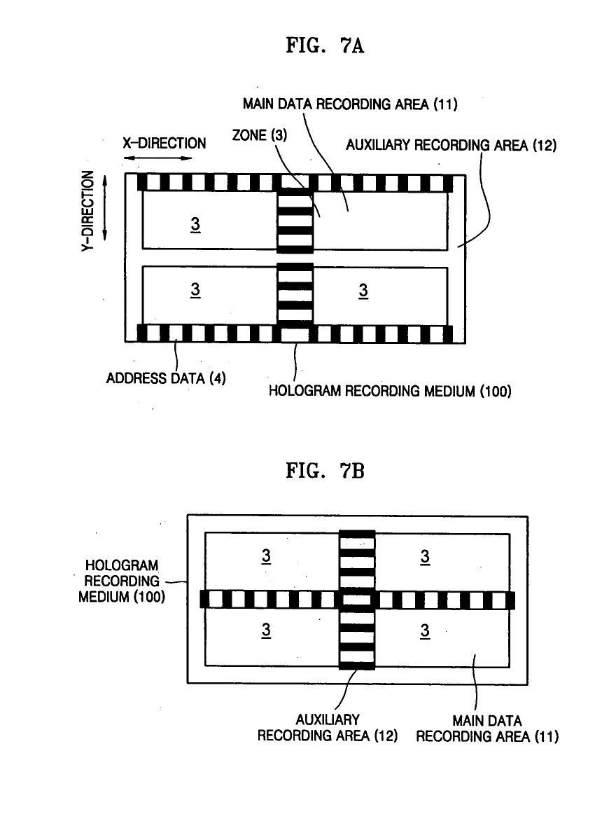

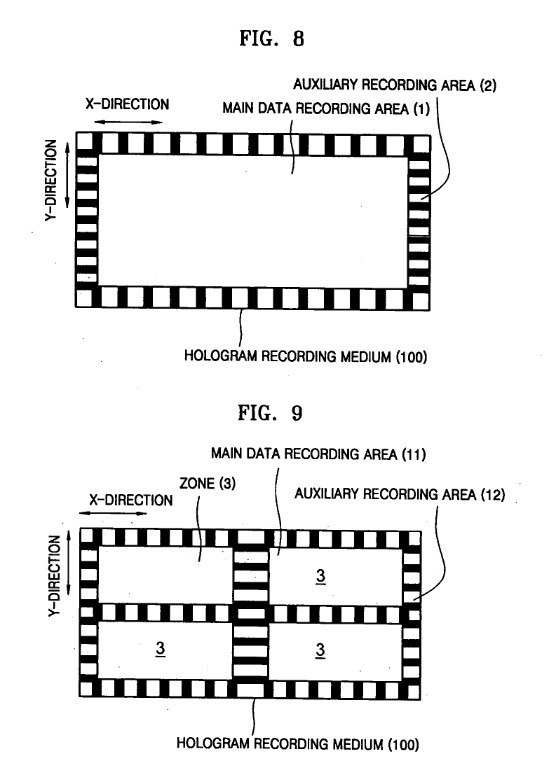

Referring to FIGS. 4A through 9, address data 4, which are necessary for recording or reproducing information, are formed in the auxiliary recording areas 2 and 12. A card shaped hologram recording medium 100 of FIG. 4 includes address data 4, which is formed at one side of an auxiliary recording area 2 along an X-direction. Alternatively, the auxiliary recording area 2 may be formed along a Y-direction. In this case, the auxiliary recording area 2 is formed at the periphery of the card shaped hologram recording medium 100. A card shaped hologram recording medium 100 of FIG. 6 includes a pair of address data 4, which are formed in the auxiliary recording area 2 to correspond to the X-direction and the Y-direction. A card shaped hologram recording medium 100 of FIG. 8 includes two pairs of address data 4, which are formed on the auxiliary recording area 2 corresponding to the X-direction and the Y-direction, respectively. Hologram recording media 100 of FIGS. 5, 7A, 7B, and 9 include address data 4 formed at the respective peripheries of each zone 3, the recording medium 100 of FIG. 5 having address data 4 formed in the X direction relative to each zone 3 and the recording media 100 of FIGS. 7A, 7B and 9 having address data 4 formed in X and Y directions relative to each zone 3.

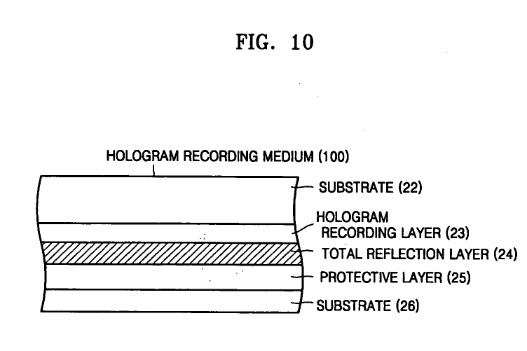

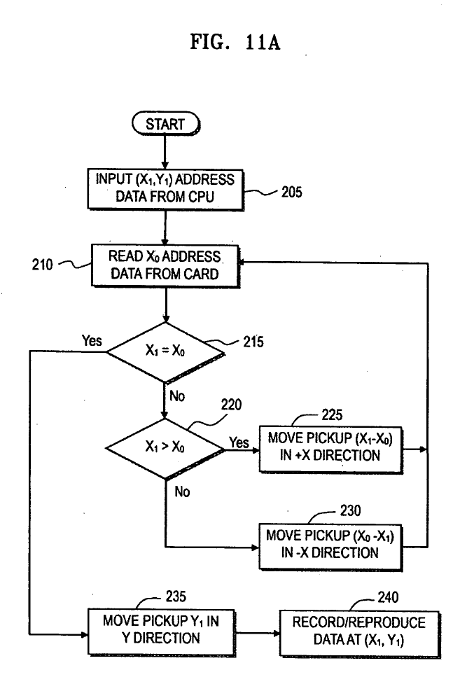

Referring to FIG. 10, a hologram recording medium 100 is formed of a substrate 22, a hologram recording layer 23, a total reflection layer 24, a protective layer 25, a coating layer (not shown), an adherence layer (not shown), and a substrate 26. Here, the substrates 22 and 26 are components forming the base of the hologram recording medium 100. The hologram recording layer 23 is formed of a photosensitive material, for example, a photopolymer, and an object beam and a reference beam are irradiated to the same region of the hologram recording layer 23 to record information of the object beam as interference fringes.

The total reflection layer 24 reflects the object beam and the reference beam irradiated to the hologram recording layer 23 and prevents the transmission of the object beam and the reference beam to a surface, which faces a surface having a data recording area. The protective layer 25 physically protects concave shaped or convex shaped servo data formed on the substrate 26 from the outside. In addition, pits (not shown) corresponding to the address data 4 are formed at the periphery of the data recording area.

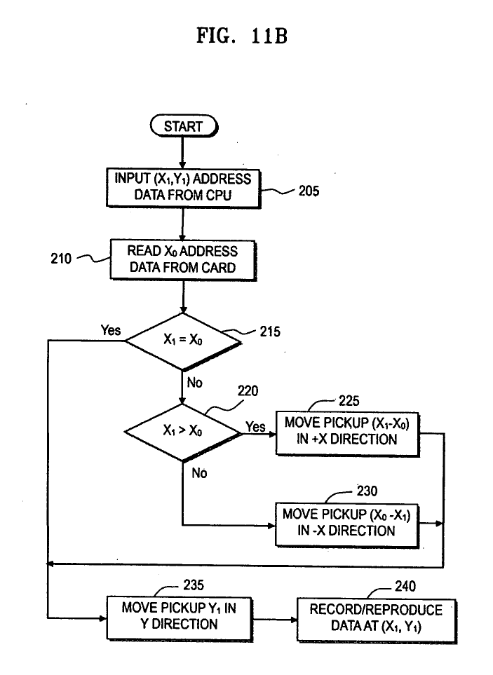

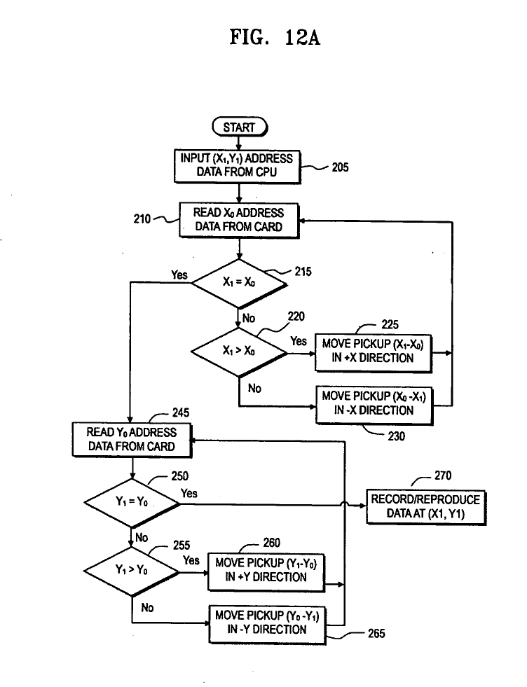

Methods of controlling a location determination by using address data of a hologram recording medium having address data in one axis direction will now be described with reference to FIGS. 11A and 11B. A drive apparatus for recording information on a hologram recording medium 100 of FIGS. 4A, 4B or 5 includes an optical pickup for recording/reproducing information and a transfer unit of transferring the optical pickup in the Y-direction of FIGS. 4A, 4B or 5.

Referring now to FIG. 11A, a first method of locating a recording start address is illustrated. In order to record information on the hologram recording medium of FIG. 4A or 4B, initially, a recording start address, for example, X=X₁ and Y=Y₁, is input at operation 205 by a CPU (not shown) of the drive apparatus. The optical pickup reads address data 4 in the X-direction (X₀) of a current location of the pickup and outputs the read address data 4 (X₀) to the CPU at operation 210. The CPU compares the read address data (X₀) with the recording start address (X₁) at operation 215. If the input recording start address (X₁) equals the read address, no motion in the X direction is necessary and the drive apparatus moves the pickup Y₁ in the Y direction at operation 235 to control the optical pickup to a position to record/reproduce data at (X₁, Y₁). If X₁ is not equal to X₀, X₁ and X₀ are compared at operation 220. In operation 220, if X₁ is greater than X₀, the drive apparatus moves the pickup (X₁-X₀) in the +X direction at operation 225 and returns to operation 210 to read a new X₀ from the recording medium. In operation 220, if X₁ is not greater than X₀, the drive apparatus moves the pickup (X₀-X₁) in the −X direction and returns to operation 210 to read a new X₀ from the recording medium. The newly read X₀ is again compared with the X₁ input by the CPU to verify the location of the pickup. If the drive apparatus has accurately moved the pickup, the newly read X₀ will equal the input address X₁ and the method will proceed to operation 235 as described above. Accordingly, the recording/reproducing optical pickup may be precisely transferred to the recording start address.

When information is previously recorded on the hologram recording medium 100 of FIGS. 4A and 4B, the recording start address, for example, X=X₂ and Y=Y₂, is input from the CPU in the drive apparatus. A method of searching a reproducing target address in the hologram recording medium 100 shown in FIG. 4 is the same as described above for the recording target address. That is, a search is first made in the X direction for the value X₂ and then the optical pickup is transferred along the Y direction by an amount Y₂. The searching of a reproducing target address is illustrated in FIG. 11A when X₂ and Y₂ are substituted for X₁ and Y₁, respectively.

Referring now to FIG. 11B, a second method of locating a recording start address or a reproducing start address is illustrated. The second method operates similarly as the first method and differs in that after the pickup is moved in the +X direction or the −X direction in response to operation 225 or operation 230, respectively, the method proceeds directly to operation 235 without returning to operation 210 as in first method described with respect to FIG. 11A.

In order to record information on the hologram recording medium of FIG. 5, address data 4 corresponding to zone data (i.e., an identification of one of the zones 3) and a recording start address of the zone, for example, X=B and Y=B, are addressed by a CPU (not shown) in a drive apparatus. An optical pickup reproduces the address data 4 in the X-direction from a predetermined zone and outputs the address data 4 to the CPU. The CPU compares the input address data 4 with the recording start address to control the optical pickup based on the comparison result. The first and second methods described with respect to FIGS. 11A and 11B may be analogously used with the hologram recording medium shown in FIG. 5, wherein movements in the X and Y direction correspond to movements within one of the zones 3 shown in FIG. 5.

When the optical pickup is transferred to a predetermined address in the X-direction within a zone, the CPU controls a transferring unit of the optical pickup to transfer the optical pickup by an amount corresponding to a predetermined Y-direction address within the zone. Accordingly, the recording/reproducing optical pickup may be precisely transferred to the recording start address. A searching operation for reproducing information from the hologram recording medium 100 of FIG. 5 is the same as the searching operation for recording information on the hologram recording medium 100.

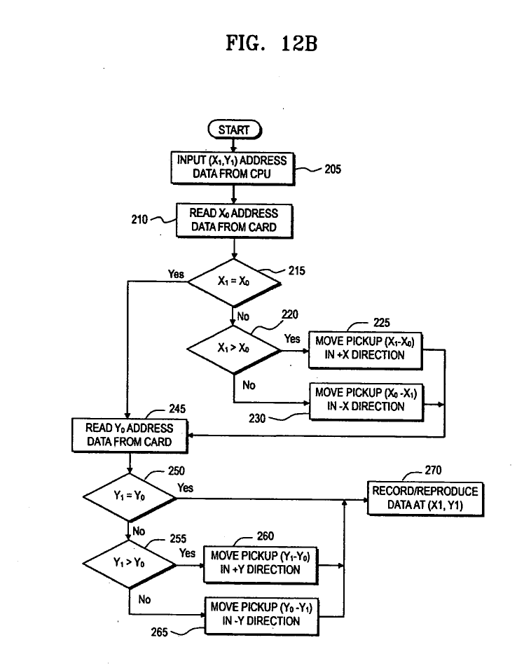

Methods of controlling a location determination by using address data of a hologram recording medium having address data in two axis directions will now be described with reference to FIGS. 12A and 12B. A drive apparatus for recording information on hologram recording media 100 of FIGS. 6 through 9 includes an address data reading optical pickup for reading address data 4 in both the X and Y directions and a data recording/reproducing optical pickup of recording/reproducing information.

Referring now to FIG. 12A, a third method of locating a recording or reproducing start address is illustrated. In order to record information on the hologram recording medium 100 of FIG. 6 initially, a recording start address, for example, X=X₁ and Y=Y₁, is input by a CPU (not shown) of the drive apparatus at operation 205. An optical pickup for reading address data 4 reproduces address data 4 in the X-direction and outputs the address data 4 (X₀) to the CPU, and the CPU compares the input address data 4 with the recording start address to control the address data reading optical pickup based on the comparison result. Operations 205, 210, 215, 220, 225 and 230 shown in FIG. 12A are the same as operations 205, 210, 215, 220, 225 and 230 described with respect to FIG. 11A and the descriptions thereof are not repeated.

After the X₁ position is determined at operation 215, address data Y₀ in the Y direction is read from the recording medium. The optical pickup reads address data 4 in the Y-direction (Y₀) of a current Y location of the pickup and outputs the read address data 4 (Y₀) to the CPU at operation 245. The CPU compares the read address data (Y₀) with the recording start address (Y₁) at operation 250. If the input recording start address (Y₁) equals the read address, no motion in the Y direction is necessary and data is recorded or reproduced at operation 270. If Y₁ is not equal to Y₀, Y₁ and Y₀ are compared at operation 255. In operation 255, if Y₁ is greater than Y₀, the drive apparatus moves the pickup (Y₁-Y₀) in the +Y direction at operation 260 and returns to operation 245 to read a new Y₀ from the recording medium. In operation 255, if Y₁ is not greater than Y₀, the drive apparatus moves the pickup (Y₀-Y₁) in the −Y direction at operation 265 and returns to operation 245 to read a new Y₀ from the recording medium. The newly read Y₀ is again compared with the Y₁ input by the CPU to verify the location of the pickup. If the drive apparatus has accurately moved the pickup, the newly read Y₀ will equal the input address Y₁ and the method will proceed to operation 270 as described above.

Referring now to FIG. 12B, a fourth method of locating a recording start address or a reproducing start address is illustrated. The fourth method operates similarly as the third method and differs in that after the pickup is moved in the +X direction or the −X direction in response to operation 225 or operation 230, respectively, the method proceeds directly to operation 245 without returning to operation 210 as in the third method described with respect to FIG. 12A. Further, after the pickup is moved in the +Y direction or the −Y direction in response to operation 260 or operation 265, respectively, the method proceeds directly to operation 270 without returning to operation 245 as in the third method described with respect to FIG. 12A.

The address data reading optical pickup and the recording/reproducing optical pickup are mechanically connected, and thus when transferring the address data reading optical pickup to a predetermined address in the X-direction, the location of the recording/reproducing optical pickup in the X-direction is locked. In addition, when the X-direction address of the address data reading optical pickup is determined, the address data reading optical pickup is returned to the original position. Thereafter, the Y-direction address data 4 is reproduced and output to the CPU. The CPU compares the address data 4 with the recording start address and controls the address data reading optical pickup based on the comparison result.

In addition, the address data reading optical pickup and the recording/reproducing optical pickup are mechanically connected. When the address data reading optical pickup reaches a predetermined X-direction address, the recording/reproducing optical pickup is locked, and the recording/reproducing optical pickup is transferred to a predetermined Y-direction address along the transfer of the address data reading optical pickup from the predetermined X-direction address. Accordingly, the recording/reproducing optical pickup may be precisely transferred to the recording start address.

When information is previously recorded on the hologram recording medium 100 of FIG. 6, a recording start address, for example, X=X₁ and Y=Y₁, is addressed by a CPU (not shown) of a drive apparatus; however, a method of searching a target address is the same as described above. In addition, a searching operation for reproducing information from the hologram recording medium 100 of FIG. 6 is the same as described above with respect to FIGS. 4A and 4B.

When recording information on the hologram recording medium 100 of FIG. 8, a searching operation is the same as described above; however, the searching operation may be performed more rapidly by using address data 4 located around a target address, because two pairs of address data 4 of X-direction and Y-direction are recorded on the periphery of the hologram recording medium 100.

When recording information on a hologram recording medium 100 of FIG. 7A, address data 4 corresponding to zone data and a recording start address of the zone, for example, X=B and Y=B, are addressed by a CPU (not shown) of a drive apparatus. An address data reading optical pickup reproduces the X-direction address data 4 formed in a predetermined zone and outputs the reproduced address data 4 to the CPU. The CPU compares the input address data 4 with the recording start address and controls the address data reading optical pickup based on the comparison result.

In addition, the address data reading optical pickup and the recording/reproducing optical pickup are mechanically connected. When the address data reading optical pickup reaches a predetermined X-direction address, the recording/reproducing optical pickup is locked, and the recording/reproducing optical pickup is transferred to a predetermined Y-direction address along the transfer of the address data reading optical pickup from the predetermined X-direction address. Accordingly, the recording/reproducing optical pickup may be precisely transferred to the recording start address.

When information is previously recorded on the hologram recording medium 100 of FIG. 7, address data 4 corresponding to zone data and a recording start address of the zone, for example, X=N and Y=M, are addressed by a CPU (not shown) of a drive apparatus; however, a method of searching a target address is the same as described above. In addition, a searching operation for reproducing information from the hologram recording medium 100 of FIG. 7 is the same as described above.

When recording information on the hologram recording medium 100 of FIG. 9, a searching operation is the same as described above; however, the searching operation may be performed more rapidly by using address data 4 located around a target address, because two pairs of address data 4 are recorded on the peripheries of the zones on the hologram recording medium 100.

Accordingly, a location determination operation may be precisely performed over the main data recording area of the hologram recording medium according to the present invention by using the X-direction and Y-direction address data formed at the periphery of the hologram recording medium or the periphery of the zones on the hologram recording medium.

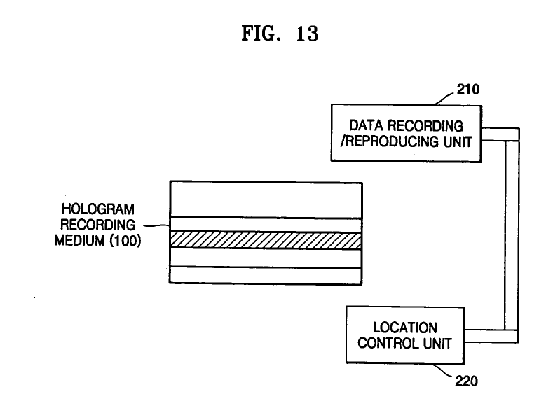

FIG. 13 is a block diagram illustrating a recording/reproducing apparatus for a hologram recording medium according to the present invention.

Referring to FIG. 13, a recording/reproducing apparatus for a hologram recording medium according to the present invention includes a data reproducing unit 210 and a location control unit 220.

The data recoding/reproducing unit 210 receives a recording or reproducing start address which is addressed by a CPU(not shown) of the drive apparatus. The data recoding/reproducing unit 210 reproduces address data and outputs the address data to the location control unit 220. The location control unit 220 compares the input address with the recording or reproducing start address to control the pickup based on the comparison and moves the optical pickup in a direction corresponding to the side based on the comparison result as described above. Accordingly, the recording/reproducing optical pickup may be precisely transferred to the recording start address.

Various changes in form and details may be made to embodiments of the present invention without departing from the spirit and scope of the present invention. For example, a method of searching a predetermined address by using address data in a main data recording area has been described; however, separate address data may be included in the main data to perform a brief search by using address data in a main data recording area and to reach a predetermined address by using the address data in the main data.

Also, a hologram recording medium according to the present invention may include a recordable medium formed of a photopolymer, a rewritable medium formed of LiNbO₃, and a multilayered waveguide type medium.

According to the present invention, predetermined data may be precisely detected in a short time by easily obtaining address data while minimizing the reduction of a recording capacity.

In addition, predetermined data may be precisely detected in a short time from a hologram recording medium having main data recording areas in each zone by easily obtaining address data of the zones.

Although a few embodiments of the present invention have been shown and described, it would be appreciated by those skilled in the art that changes may be made in this embodiment without departing from the principles and spirit of the invention, the scope of which is defined in the claims and their equivalents.

1. A card shaped hologram recording medium comprising:
a main data recording area; and
an auxiliary data recording area arranged at a periphery of the main data recording area.

2. The hologram recording medium of claim 1, wherein address data is included in the auxiliary recording area.

3. The hologram recording medium of claim 2, wherein the auxiliary recording area is arranged on a plurality of sides of the main data recording area and the address data is arranged on at least at one side of the auxiliary data recording area.

4. The hologram recording medium of claim 2, wherein the auxiliary recording area is arranged on a plurality of sides of the main data recording area and the address data is arranged on at least two sides of the auxiliary data recording area.

5. The hologram recording medium of claim 4, wherein:
on one of the at least two sides, the address data corresponds to a first direction; and
on another of the at least two sides, the address data corresponds to a second direction.

6. The hologram recording medium of claim 4, wherein two of the at least two sides of the auxiliary recording area correspond to address data in a same direction.

7. The hologram recording medium of claim 2, wherein the address data is formed of printed marks.

8. The hologram recording medium of claim 3, wherein the address data is formed of printed marks.

9. The hologram recording medium of claim 4, wherein the address data is formed of printed marks.

10. The hologram recording medium of claim 2, wherein the address data is formed of concave units or convex units.

11. A card shaped hologram recording medium comprising:
a main data recording area, which is divided into a plurality of zones; and
an auxiliary recording area arranged at peripheries of the zones.

12. The hologram recording medium of claim 11, wherein the auxiliary data recording area includes address data.

13. The hologram recording medium of claim 12, wherein the address data are arranged at least at one side of each zone.

14. The hologram recording medium of claim 12, wherein the address data are formed of printed marks.

15. The hologram recording medium of claim 12, wherein the address data are formed of concave units or convex units.

16. The hologram recording unit of claim 12, wherein:
the address data are arranged on at least two sides of each zone.

17. The hologram recording medium of claim 16, wherein:
the address data on one side of each zone corresponds to an address in a first direction within a respective zone; and
the address data on another side of each zone corresponds to an address in a second direction within the respective zone.

18. The hologram recording medium of claim 16, wherein the address data on two of the at least two sides of each zone correspond to address data in a same direction.

19. A method of recording information on and/or reproducing information from a holographic storage medium having a user data recording area for recording reproducible data and an auxiliary recording area having recorded address data along a first side of the user data recording area, the method comprising:
inputting a recording address having a first component;
reading an address of a current location of an optical pickup from the recorded address data along the first side of the user data recording area;
comparing the first component of the input address with the read address; and
moving the optical pickup in a direction corresponding to the first side based on the comparison.

20. The method of claim 19, wherein:
the input address further comprises a second address component orthogonally related to the first side; and
the method further comprises moving the optical pickup orthogonally to the first side by an amount determined by the second address component after moving the optical pickup in the direction corresponding to the first side.

21. The method of claim 19, wherein:
the auxiliary recording area has recorded address data along a second side of the main data recording area;
the input address further comprises a second address component orthogonally related to the first side; and
the method further comprises:
reading an address of a current location of the optical pickup from the recorded address data along the second side of the user data recording area,
comparing the second address component with the read address along the second side of the user data recording area, and
moving the optical pickup in a direction corresponding to the second side based on the comparison.

22. The method of claim 19, wherein:
the holographic storage medium comprises a plurality user data areas; and
the method further comprises inputting an identification of one of the user data areas.

23. The method of claim 20, wherein:
the holographic storage medium comprises a plurality user data areas; and
the method further comprises inputting an identification of one of the user data areas.

24. The method of claim 21, wherein:
the holographic storage medium comprises a plurality user data areas; and
the method further comprises inputting an identification of one of the user data areas.

25. The method of claim 19, further comprising:
recording additional address data on the user data area.

26. The method of claim 19, further comprising:
verifying the moved location of the optical pickup in the direction corresponding to the first side by reading address data along the first side of the user data recording area after the moving of the optical pickup in the direction corresponding to the first side.

27. The method of claim 20, further comprising:
verifying the moved location of the optical pickup in the direction corresponding to the first side by reading address data along the first side of the user data recording area after the moving of the optical pickup in the direction corresponding to the first side.

28. The method of claim 21, further comprising:
verifying the moved location of the optical pickup in the direction corresponding to the second side by reading address data along the second side of the user data recording area after the moving of the optical pickup in the direction corresponding to the second side.

29. A recording/reproducing apparatus for holographic storage medium having a user data recording area for recording reproducible data and an auxiliary recording area having recorded address data along a first side of the user data recording area, the apparatus comprising:
a data recording/reproducing unit which receives at least a first recording/reproducing address component and reads an address of a current location of an optical pickup from the recorded address data along the first side of the user data recording area; and
a location control unit which compares the first component of the input address with read address and moves optical pickup in a direction corresponding to the first side based on the comparison.

30. The apparatus of claim 29, wherein:
the data recording/reproducing unit further receives a second address component orthogonally related to the first side; and
the location control unit further moves the optical pickup orthogonally to the first side by an amount determined by the second address component after moving the optical pickup in the direction corresponding to the first side.

31. The apparatus of claim 29, wherein:
the auxiliary recording area has recorded address data along a second side of the main data recording area;
the input address further comprises a second address component orthogonally related to the first side; and
the data recording/reproducing unit reads an address of a current location of the optical pickup from the recorded address data along the second side of the user data recording area; and
the location control unit compares the second address component with the read address along the second side of the user data recording area, and moves the optical pickup in a direction corresponding to the second side based on the comparison.

32. The apparatus of claim 29, wherein:
the data recording/reproducing unit reads an address of a current location of the optical pickup from the recorded address data along the first side of the user data recording area after the optical pickup is moved in the first direction, to verify the moved location.

33. The apparatus of claim 30, wherein:
the data recording/reproducing unit reads an address of a current location of the optical pickup from the recorded address data along the first side of the user data recording area after the optical pickup is moved in the first direction, to verify the moved location.

34. The apparatus of claim 31, wherein:
the data recording/reproducing unit reads an address of a current location of the optical pickup from the recorded address data along the second side of the user data recording area after the optical pickup is moved in the second direction, to verify the moved location.
